(19) United States
(12) Patent Application Publication
(10) Pub. No.: US 2004/0200423 A1
(43) Pub. Date: Oct. 14, 2004

(54) Alternative efficient milking method

(76) Inventor: Carl T. Muirbrook, Turlock, CA (US)

Correspondence Address: GEORGE S. COLE, ESQ., 495 SEAPORT COURT, SUITE 101, REDWOOD CITY, CA, 94063, US

(21) Appl. No.: 10/706,699

(22) Filed: Nov. 12, 2003

Related U.S. Application Data
(63) Continuation-in-part of application No. 10/412,496, filed on Apr. 11, 2003.

(51) Int. Cl. A01J 5/00; A01J 3/00

(52) U.S. Cl. 119/14.02

(57) ABSTRACT

A method for milking animals, particularly domesticated dairy animals, and most particularly dairy cattle, that improves milk/food sanitation, labor and cost efficiency, environmental friendliness, and throughput, that uses a wet prep, reduces both interactions with the animal being milked and delays between steps during which recontamination of teats can happen. The best method comprises the steps of sanitizing the animal's teats, then without drying or removing the sanitizing composition priming the animal's teats, followed by attaching a feeder tube to a milking machine to each teat, and completing the milking.

### CROSS REFERENCE TO RELATED APPLICATIONS

This is a continuation in part of Ser. No. 10/412,496, filed on Apr. 11, 2003.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND

1.A. Field of the Invention

This invention is in the field of methods for milking animals. While the application and the preferred embodiment primarily describe the method with reference to milking domesticated dairy cattle, the method of this invention is equally suitable for sheep, goats, and other domesticated dairy mammals, and also suitable for other mammalian milking opportunities.

2. Description of the Related Art

The prior art, as described in the original application Ser. No. 10/412,496, “A Method for Efficient Milking”, filed on Apr. 11, 2003, addressed a new method for milking which in contravention to existing practice used a ‘wet prep’. For the reasons and advantages listed in the prior application, inventor created the invention described therein. The prior art references, definitions, and description of the parent application are hereby specficially incorporated into this continuation-in-part.

Further enhancements and improvements have been created by the inventor since the parent application was filed, in response to problems and concerns which were discovered during initial experimentation and introduction into the commercial dairy-farms. A chief problem for some established dairies with the original application's invention, was that it did not use their pre-existing capital equipment. That increased the perceived cost and reluctance to adopt that method. A second problem was that the original application's invention encountered confusion and clashes arising out of the extant expectations and practices of the dairy owners, operators, and laborers. A third problem was the concern that the dairy animals might have trouble accepting the change all at once, for cows are neither the smartest nor the most adaptable of domesticated animals. The applicant soon realized that it would be wise to devise a partial adaptation which, though less effective overall than the original invention, might lead to speedier and broader adoption and adaptation which would eventually lead to the full adoption of the original invention.

In the prior art, the use of capital equipment in the form of sprayers or dip cups to apply germicidal and sanitizing compositions to the teats of dairy animals is both well known and widely extant. Additionally, a great many of the dairy animals are already conditioned to and expect the use of one or the other, depending upon the pre-existing practice of a particular dairy. Wiping contamination (typically feces) off an udder or teat when such is observed, is seldom required; the contamination is rarely and unpredictably present, and that response is already part of the prior art. Accustoming one cow, or a herd of cows, (or a herd of any other dairy animal) to a new process can take time, effort, and create an interim loss of productivity which some dairy operators are loathe to accept. Furthermore, the cost of immediately transitioning over to the method in the parent invention may be distorted due to the vagaries of tax and accounting practices, thereby reducing its relative and immediate desirability. Overall, these factors and others reduced desirability and relative advantage for the parent invention, but can be met by the method disclosed in this continuation-in-part.

### OBJECTS OF THE INVENTION

The primary object of the invention is improved use of pre-existing capital equipment and better match to existing expectations and considerations of the preferred method for milking in existing operations.

A secondary object of the invention is providing flexibility to meet particular environmental or other operational constraints which make the method of the parent invention less acceptable or desirable to a dairy.

A third object is to enable a partial adaptation to the new, ‘wet prep’ approach which improves the acceptability and value of the method, granting some of the advantages, albeit somewhat less than might be gained, of the parent method.

### SUMMARY OF THE INVENTION

An alternative efficient milking method, comprising the steps of preparing each teat of an animal to be milked, followed by priming each teat, followed by attaching a feeder tube to a milking machine, is described herein with the preferred and alternative embodiments detailed below.

### BRIEF DESCRIPTION OF THE DRAWINGS

The drawings constitute a part of this specification and include exemplary embodiments to the invention, which may be embodied in various forms. It is to be understood that in some instances various aspects of the elements affected by or used in the process may be shown in abstraction to facilitate an understanding of the invention.

FIG. 1 is an illustrative representation of the method disclosed herein, using a dip cup (44).

FIG. 2 is an illustrative representation of the method dislosed herein, using a sprayer (46).

FIG. 3 is a flowchart of the method for milking a dairy animal.

### DETAILED DESCRIPTION OF THE DRAWINGS

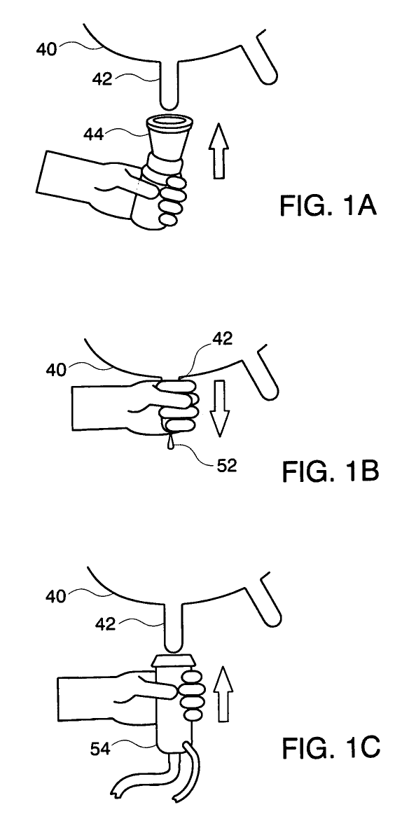

FIG. 1 is an illustration such as might be issued to a milker (who may be a non-literate or non-English speaking laborer) responsible for milking each animal, using a drawing style which is both highly abstracted and similar to that found in OSHA, CAL-OSHA, and similar industrial and retail operations. The three basic steps are illustrated sequentially from top to bottom. In FIG. 1A, the milker applies a prepared dip cup (44) (into which the germicidal and sanititzing solution, which in the preferred embodiment incorporates an emollient as part of the composition, has been placed) to a teat (42) of the cow's udder (40). In FIG. 1B, the milker manually strips each teat (42) with a downward motion, priming the teat, squeezing out pre-milking solids or teat-end contamination, and stimulating the cow's milk let-down (52). In FIG. 1C, the milker attaches to the teat a feeder cup (54) to a milking machine. Each of these sub-steps (1A, 1B, 1C) will be repeated for each teat; and the entire method will be repeated for each cow milked per session.

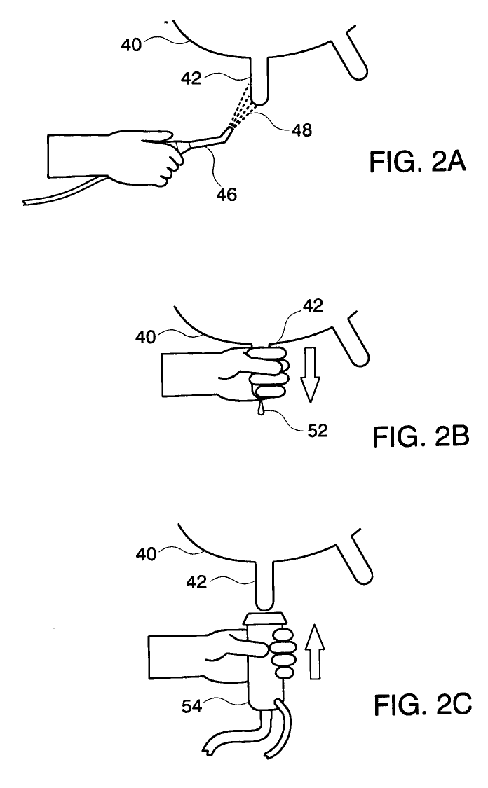

FIG. 2 only differs from FIG. 1 in depicting the use of a sprayer (46) to spread the germicidal and sanitizing compound over the teat.

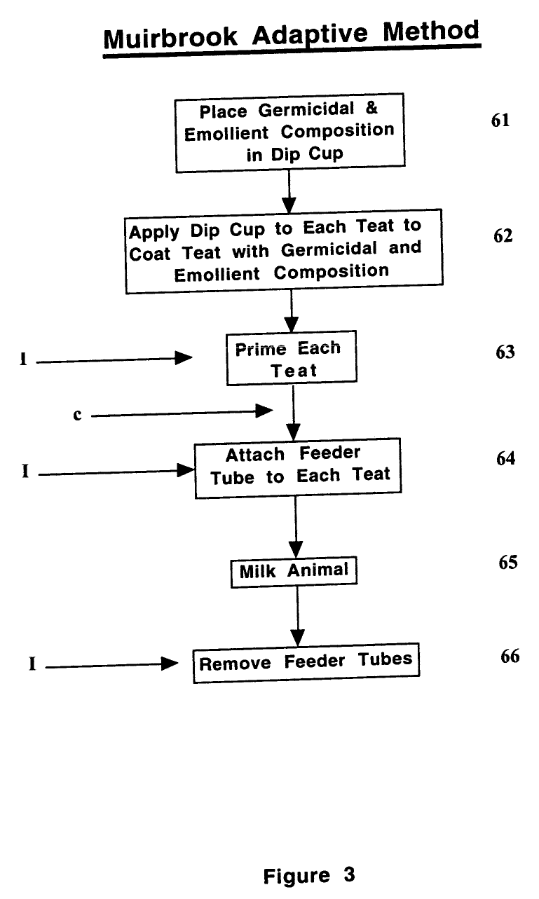

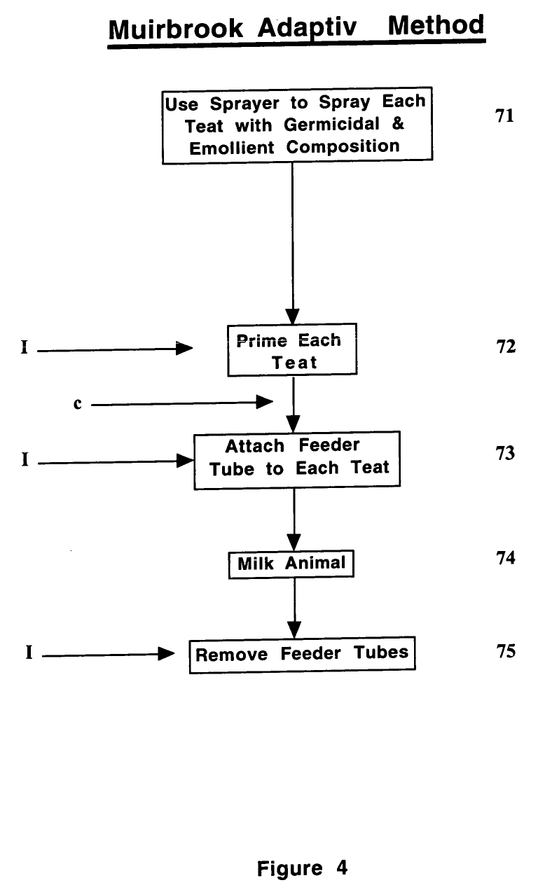

FIG. 3 is a flowchart indicating the steps (61-66) of the method, and the interactions between the milker and the animal (indicated by an ‘I’), and the delays between steps which present opportunities for unwanted recontamination of the teat(s) (indicated by a ‘c’), for using a dip cup to apply the germicidal and sanitizing composition.

FIG. 4 is a flowchart indicating the steps (71-75) of the method, and the interactions between the human milker and the animal (indicated by an ‘I’), and the delays between steps which present opportunities for unwanted recontamination of the teat(s) (indicated by a ‘c’), for using a sprayer to apply the germicidal and sanitizing composition, which in the preferred embodiment incorporates an emollient as part of the composition.

### DETAILED DESCRIPTION OF THE PREFERRED AND ALTERNATIVE EMBODIMENTS

Detailed descriptions of the preferred, and various alternative, embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. Also, different combinations of the sub-steps of the various embodiments than those shown, claimed or described should be understood to be included in the invention as equivalent to one or more of the particular embodiments detailed herein.

In the parent invention, the method therein disclosed as its best method the application of the germicidal and sanitizing solution to the individual teats of the dairy animal by hand, that is, from the hands of the milker directly to the teats of the animal being milked.

There are some herds, and indeed some particular animals, for which a hand application is unacceptable. Alternative means of applying a germicidal and sanitizing composition already exist in the prior art, in the form of sprayers (hand, or fixed) and dip cups. These alternative means do not require direct physical contact between the milker and the dairy animal, though each has its own disadvantage (the sprayer generally being more wasteful of composition, and the dip cup taking more time and manual dexterity).

An alternative method to that described in the parent invention uses the existing, paid-for, and accepted non-manual means for applying the germicidal and sanitizing solution to prepare the animal's teats for milking. Next, in contravention to the prior art, the milker does not wash off, towel off, or otherwise remove that germicidal and sanitizing solution, but instead proceeds to prime the animal's teats. Then the milker attaches a feeder tube to a milking machine to each teat. This attachment is made as immediately as possible after the priming in the preferred embodiment, but may be made after an interval for drying and devolatilization of the germicidal and sanitizing solution, in an alternative embodiment.

Thus in one embodiment of this invention, a milker will use a sprayer to prepare each teat of the animal to be milked; while in another embodiment, the milker will use a dip cup to prepare each teat of the animal to be milked; the two embodiments differ by the implement chosen to apply a germicidal and sanitizing solution to each teat of the animal to be milked.

After each teat is prepared, the milker will next prime each teat. In the preferred embodiment, this will be done as immediately as possible, as described in the parent invention for the purposes and advantages stated therein. In an alternative embodiment, where the germicidal and sanitizing solution contains ingredients which must dry or become inactive by the passage of a certain amount of time (e.g. should that solution contain iodine, which must devolatalize before the milk is extracted from the animal's udder lest the iodine contaminate the collected milk), the milker will let the necessary time intervene between the steps of priming each teat and attaching a feeder tube to each teat. After the milk has been collected from the animal's udder, the milking process will end, perhaps with a second composition being applied or not, as already happens in the prior art.

Substitution of automated machinery for spraying teats, applying a dip cup to a teat, priming a teat, and even attaching and removing a feeder tube to and from a teat, is within the present scope of the prior art, though the particulars of each such machine may be the subject of one or more inventive steps. One further embodiment of this invention is the substitution of a non-human implementation through such automated machinery for the human milker.

The scope of this invention includes any combination of the steps from the different embodiments disclosed in this specification, and is not limited to the specifics of the preferred embodiment or any of the alternative embodiments mentioned above. Individual user applications and embodiments of this invention may contain all, or less than all, of the steps disclosed in the specification according to the needs, proclivities, handedness, and desires of that user or the animal being milked. The claims stated herein should be read as including those elements and steps which are not necessary to the invention yet are in the prior art and are necessary to the overall function of that particular claim, and should be read as including, to the maximum extent permissible by law, known functional equivalents to the elements and steps disclosed in the specification, even though those functional equivalents are not exhaustively detailed herein. Accordingly, it is intended that the appended claims are interpreted as covering all alterations and modifications as fall within the true spirit and scope of the invention in light of the prior art.

Additionally, although claims have been formulated in this application to particular combinations of steps or actions, it should be understood that the scope of the disclosure of the present application also includes any single novel step or any novel combination of steps disclosed herein, either explicitly or implicitly, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

Any element in a claim that does not explicitly state “step for” performing a specified function is not to be interpreted as a “step” clause as specified in 35 U.S.C. §112, ¶ 6. In particular, the use of “step of” in the claims herein is not intended to invoke the provisions of 35 U.S.C. §112, ¶ 6.

I claim:

1. A method for milking, comprising:
a step of preparing each teat;
followed by a step of priming each teat;
followed directly by a step of attaching a feeder tube from a milking machine to each teat.

2. A method as in claim 1, wherein the step of preparing a teat further comprises spraying a germicidal and sanitizing composition on said teat.

3. A method as in claim 1, wherein the step of preparing a teat further comprises immersing said teat in a dip cup containing a germicidal and sanitizing solution.

4. A method as in claim 1, wherein the step of attaching a feeder tube from a milking machine to each teat follows as immediately as possible after the step of priming each teat.

5. A method as in claim 2, wherein the step of attaching a feeder tube from a milking machine to each teat follows after a sufficient interval for the germicidal and sanitizing solution to dry and devolatilize.

6. A method as in claim 2, wherein the steps of preparing, priming, and attaching a feeder tube from a milking machine, to each teat, are performed by automated machinery.

7. A method as in claim 6, wherein the steps of preparing, priming, and attaching a feeder tube from a milking machine, to each teat, are performed by automated machinery in conjunction with a human laborer
